(19) United States
(12) Patent Application Publication
(10) Pub. No.: US 2010/0087562 A1
(43) Pub. Date: Apr. 8, 2010

(54) Polyurethane Foam Batt Insulation

(76) Inventors: Salvatore Anthony Diloreto, Brantford (CA); Simon Asaro, Concord (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/530,218

(22) PCT Filed: Mar. 6, 2008
(86) PCT No.: PCT/CA2008/000464

§ 371 Date: Sep. 7, 2009

Related U.S. Application Data
(60) Provisional application No. 60/893,461, filed on Mar. 7, 2007.

(51) Int. Cl. C08G 18/00

(52) U.S. Cl. 521/170; 521/155

(57) ABSTRACT

Polyurethane foam materials are produced and used in batt form, and therefore are substitutes for insulation batts previously made of fibreglass insulation The polyurethane batts are preferably made of a flexible, and compressible foam material, such that the batts can be compressed and placed within a shipping container, and so that the compressed batt will form a friction fit in an opening, when in use An alternative insulation material and format are provided.

### FIELD OF THE INVENTION

The present invention relates to the field of flexible foam materials, and in particular, relates to the use of polyurethane flexible foam materials in batt form, for building construction insulation applications.

### BACKGROUND OF THE INVENTION

Fiberglass batt insulation is well known and has been used for decades in various building construction insulation applications. Primarily, these applications involve the insulation of exterior walls and ceilings to minimize heat loss, however, other applications such as sound dampening are also known. While loose fiberglass insulation can also be used in some applications, such as when blown into attics and enclosed wall spaces, the use of fibreglass batts still dominates a large percentage of the marketplace.

Traditionally, the fibreglass batt is sized so as to have a width that will just fit, under slight compression, within the span between two wall studs, or ceiling joists. As such, the batt is typically sized so as to be about 12 to 24 inches, and just slightly larger than the gap between the wall studs or joists. The depth of the batt depends on the wall or attic space available, and the degree of insulation desired or required. The batt can be provided in any suitable length, however, and be either cut on site, or provided in easily handled lengths, such as, for example, 4 foot lengths.

Alternatively, a larger, wider batt can be supplied wherein a roll of insulation is provided of indeterminate width, and which can be used as a wrap around, for example, the inside of an unfinished basement wall.

However, there are several problems with fibreglass batt insulation. First, fibreglass fibers floating in the air, can be an irritant to the installer so that special precautions are necessary such as breathing masks and/or supplying filtered air to the installer. Alternatively, batt encased in plastic film are also known, however, this adds to the cost of the insulation installation. Further, fibreglass batts can be easily rendered permanently ineffective if they are exposed to excessive amounts of water, such as might occur in a building construction area. Additionally, the fibreglass batt, per se, provides little or no vapour barrier protection unless and until it is combined with a plastic film, or the like, which has been designed for that purpose.

Recently, however, other materials have been used in these applications. These include for example rigid foamed polystyrene panels which can be fitted to the exterior or interior of a wall structure. Also, two part polyurethane foams have also been recently used for insulation purposes wherein a two component system is mixed and immediately sprayed onto a surface to be insulated. Once on the surface, the polyurethane reacts and expands to form a foam insulation material. Typically, this foam dries to a rigid or semi-rigid structure which adheres to the structure surface. While good insulation protection can be provided, the system requires a trained operator to be present, with sophisticated application equipment.

Further, it is noted that compressed cans of polyurethane materials can be used to insulate small areas, such as cracks or openings around windows or doors, for example. However, these systems are only practical for smaller areas.

Also, it is known that polyurethane insulation has been used in large sheets as a rigid material for use in applications such as in freezer or refrigerator insulation. Again, while these rigid panels might have some utility in building construction as a foamed polystyrene replacement, further improvement to provide a material more useful to insulating between stud walls or ceiling joists would be beneficial.

As such, it would be beneficial to provide an easier method for the use of polyurethane insulation in construction or other insulation application. This includes insulation provided as part of new construction, repair of existing structures, or additional insulation to be combined with pre-existing insulation.

### SUMMARY OF THE INVENTION

It is an objective of this invention to provide a polyurethane foam, and preferably a rigid, semi-rigid or, more preferably, a flexible or semi-flexible polyurethane foam material which can be used as an insulation material, wherein the polyurethane foam material is provided in a batt format.

In particular, it is a further objective of the present invention to provide a flexible or semi-flexible polyurethane foam material which is compressible so that it can be provided to the user as a compressed batt which will expand once removed from its shipping container. Moreover, by being compressible, the polyurethane batt can be used in order to fit within, and thus be held within the space provided between wall studs and/or ceiling joists.

Further, it is a still further objective of the present invention to provide a flexible or semi-flexible and compressible polyurethane material in a batt format, which can be supplied in roll form so as to provide a construction wrap for spanning larger areas.

It is a yet still further objective of this invention to provide a method to produce a flexible or semi-flexible, compressible, polyurethane foam insulation material for use as an insulating batt, by using conventional and known manufacturing processes including compression molding, calendaring, extruding, or other forming methods.

As such, it would therefore be advantageous to provide a polyurethane foam material useful as a rigid, semi-rigid, or more preferably a semi-flexible or flexible and compressible polyurethane foam insulation, and a method for producing such an batt insulation, which would be able to fully or at least partially satisfy any or all of the above objectives.

It has now been found that satisfying any or all of the objectives set out hereinabove, as well as other objectives and goals inherent thereto, can be at least partially or fully achieved by the polyurethane foam batt insulation material of the present invention, as well as a production method therefor, as set out hereinbelow.

Accordingly, in one aspect, the present invention provides use of a rigid, semi-rigid, or more preferably, a semi-flexible or flexible polyurethane foam material as a insulation material, wherein said polyurethane material is provided as a foam material in the shape of an insulation batt. The insulation batt is adapted to be attached to a building structure, such as a wall, roof, or foundation structure in a residential, commercial or industrial building, and provide insulation properties.

Preferably, the polyurethane batt is of a size and shape similar to that of prior art insulation batts, and may optionally contain or provide a vapour barrier.

In a second aspect, the present invention provides a polyurethane batt, for use in insulating a building structure, wherein said polyurethane batt is produced from a rigid, semi-rigid, semi-flexible or flexible polyurethane foam material. Most preferably, however, the polyurethane batt is produced from a semi-flexible or even more preferably, a flexible polyurethane foam.

In a third aspect, the present invention provides a method for the production of a polyurethane batt, in accordance with the present invention, wherein a polyol and an isocyanate resins are mixed together, optionally with any additional additives, and the resultant composition is introduced into a mold cavity, or extruded through a die, calendered, sprayed on a surface, or applied in some other processing method, in order to cause the polyol and isocyanate resins to react, and a gassing method to occur, in order to form a polyurethane foam in the form of a insulation batt. The polyurethane foam can be a rigid, semi-rigid, or more preferably a semi-flexible or, even still more preferably, a flexible polyurethane foam.

### DETAILED DESCRIPTION OF THE PREFERRED EMBODIMENTS

In the present application, the term “foamed polyurethane” refers to polyurethane materials having an entrained cell structure and thus has a variety of entrained voids within the polyurethane material. The foam can have an open or closed cell structure, and preferably has a density of less than 10 pounds per cubic foot, more preferably a density of between 0.1 and 5 lbs per cubic foot, and still more preferably, a density of between 0.35 and 3 lbs per cubic foot.

Largely as a result of the differences in foam density, the insulating ability (for example the “R” value) of the foam can be adjusted and/or controlled. Typical “R” values would be between the ranges of 10 and 30 for a 4 inch thickness batt, and more preferably, between 13 and 25.

The general production methods to produce polyurethane foams are well known to the skilled artisan, as is the general chemistry for production thereof. For example, the following diagram describes in general the reaction of a process to prepare a typical polyurethane material produced from an isocyanate and a polyol resins:

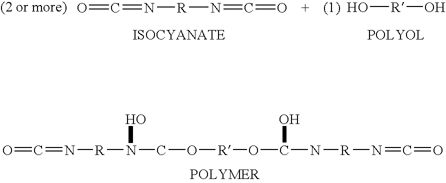

where R and R′ are used to designate any of a variety of suitable alkyl or aromatic groups.

Depending upon the type of foam structure that is required by a specific application, the isocyante and/or polyol resin systems may selected according to their molecular weight. For example, low molecular weight materials tend to promote the formation of a more rigid material. To achieve a semi-rigid material, typically, a medium molecular weight resin system is typically used. To achieve a flexible foam, a high molecular weight resin system would preferably be used. However, this selection approach is merely a guideline as to the proper selection of resin components.

As such, the flexibility of the polyurethane foam can, to a large extent, be controlled by selection of a resin having an appropriate molecular weight. For the preferred embodiment of the present application, a flexible polyurethane foam batt is one having a flexibility such that it can be bent 180 degrees or more from the horizontal, without any significant cracking or breaking of the batt. Further, a flexible polyurethane batt is one which is compressible such that it can be compressed to a batt thickness which is 60% of the original thickness of the batt without any significant cracking or breaking of the batt. Of course, once the compressive force is removed, the compressed batt will re-expand to its original thickness, or at least to a thickness which is greater than 90% of the original thickness of the batt of the present invention.

Additionally, for the purposes of the present invention, a rigid polyurethane foam is one that will crack and/or break once bent to an angle of 30° to the horizontal. A semi-rigid polyurethane form is one that will crack and/or break once bent to an angle of 90° to the horizontal. A semi-flexible polyurethane form is one that will crack and/or break only when it has been bent to an angle of between 90 and 180° to the horizontal. A semi-flexible batt is also one which can be compressed to a batt thickness which is 80% of the original batt thickness without any significant cracking or breaking of the batt.

For the purposes of the present invention, all of the above types of polyurethane foams can be used. However, flexible or semi-flexible materials are particularly preferred.

With respect to the isocyanate component, low molecular weight materials would contain from 20 to 30% isocyanate content. Medium molecular weight resins preferably contain from 12 to 20% isocyanate content, and high molecular weight resins preferably contain from 2 to 12% isocyanate content. All percentage values are by weight unless otherwise stated.

The isocyanate component of the polyisocyanate preferably has a functionality of 2.0 or more, and more preferably, a functionality of between 2.0 and 3.0, and can include diisocyanates and polyisocyanates of the aliphatic, alicyclic, or aromatic types.

The amount and type of isocyanate monomer used, or used in the production of the isocyanate resin component can directly affect the level of isocyanate groups present in the resin component. For example, hexamethylene diisocyante (HDI), has a monomeric level of isocyanate of 50% NCO. Other materials will have different monomeric NCO levels, such as, for example, Bis-(4-Isocyanatocyclohexyl) methanes (H12MDI) at 31.8% NCO; isophorone diisocyanate (IPDI) at 37.5% NCO; toluene diisocyanate (TDI) at 48% NCO; or methyl diphenyl diisocyanate (MDI) at 28-34% NCO. When reacted to form the isocyanate resin component, the monomeric NCO level will affect the isocyanate level of the resulting resin material.

The isocyanate is preferably a isocyanate selected from MDI, TDI, hexamethylene diisocyanate (HMDI), HDI, IPDI, TMXDI (1,3-bis-isocyanato-1-methylene ethylene benzene), or any of their oligomers, pre-polymers, dimmers, trimers, allophanates and uretidiones.

Further, suitable polyisocyanates useful in preparing the isocyanate resin component include, but are not limited to, toluene-2,4-diisocyanate, toluene-2,6-diisocyanate commercial mixtures of toluene-2,4- and 2,6-diisocyanates, ethylene diisocyanate, ethylidene diisocyanate, propylene-1,2-diisocyanate, cyclohexylene-1,2-diisocyanate, cyclohexylene-1,4-diisocyanate, m-phenylene diisocyanate, 3,3′-diphenyl-4,4′-biphenylene diisocyanate, 4,4′-biphenylene diisocyanate, 3,3′-dichloro-4,4′-biphenylene diisocyanate, 1,6-hexamethylene diisocyanate, 1,4-tetramethylene diisocyanate, 1,10-decamethylene diisocyanate, 1,5-naphthalenediisocyanate, cumene-2,4-diisocyanate, 4-methoxy-1,3-phenylenediisocyanate, 4-chloro-1,3-phenylenediisocyanate, 4-bromo-1,3-phenylenediisocyanate, 4-ethoxy-1,3-phenylenediisocyanate, 2,4′-diisocyanatodiphenylether, 5,6-dimethyl-1,3-phenylenediisocyanate, 2,4-dimethyl-1,3-phenylenediisocyanate, 4,4′-diisocyanatodiphenylether, benzidinediisocyanate, 4,6-dimethyl-1,3-phenylenediisocyanate, 9,10-anthracenediisocyanate, 4,4′-diisocyanatodibenzyl, 3,3′-dimethyl-4,4′-diisocyanatodiphenylmethane, 2,6-dimethyl-4,4-diisocyanatodiphenyl, 2,4-diisocyanatostilbene, 3,3′-dimethyl-4,4′-diisocyanatodiphenyl, 3,3′-dimethoxy-4,4′-diisocyanatodiphenyl, 4,4′-methylene bis(diphenyl)socyanate), 4,4′-methylene bis(dicyclohexylisocyanate), isophorone diisocyanate, PAPI (a polymeric diphenylmethane diisocyanate, or polyaryl polyisocyanate), 1,4-anthracenediisocyanate, 2,5-fluorenediisocyanate, 1,8-naphthalenediisocyanate and 2,6-diisocyanatobenzfuran.

Also suitable are aliphatic polyisocyanates such as the triisocyanate Desmodur N-100 sold by Bayer which is a biuret adduct of hexamethylenediisocyanate; the diisocyanate Hylene W sold by du Pont, which is 4,4′-dicyclohexylmethane diisocyanate; the diisocyanate IPDI (Isophorone Diisocyanate sold by Thorson Chemical Corp.), which is 3-isocyanatomethyl-3,5,5-trimethylcyclohexyl isocyanate; or the diisocyanate THMDI sold by Verba-Chemie, which is a mixture of 2,2,4- and 2,4,4-isomers of trimethyl hexamethylene diisocyanate.

Further examples of suitable isocyanate components include 2,4 tolylenediisocyanate, 2,6-tolylenediisocyanate, 4,4′-diphenylmethanediisocyanate, 4,4′-diphenylthere-diisocyanate, m-phenylenediisocyanate, 1,5-naphthalene-diisocyanate, biphenylenediisocyanate, 3,3′-dimethyl-4,4′-biphenylenediisocyanate, dicyclohexylmethane-4,4′diisocyanate, p-xylylenediisocyanate, bis(4-isocyanatophenyl) sulfone, isopropylidene bis(4-phenylisocyanate), tetramethylene diisocyanate, isophorone diisocyanate, ethylene diisocyanate, trimethylene, propylene-1,2-diisocyanate, ethylidene diisocyanate, cyclopentylene-1,3-diisocyanates, 1,2-1,3- or 1,4 cyclohexylene diisocyanates, 1,3- or 1,4-phenylene diisocyanates, polymethylene ployphenylleisocyanates, bis(4-isocyanatophenyl)methane, 4,4′-diphenylpropane diisocyanates, bis(2-isocyanatoethyl) carbonate, 1-methyl-2,4-diisocyanatocycloheane, chlorophenylene diisocyanates, triphenylmethane-4,4′4″-triisocyanate, isopropyl benzene-a-4-diisocyanate, 5,6-diisocnanatobutylbicyclo[2.2.1]hept-2ene, hexahydrotolylene diisocyanate, 1-methoxyphenyl-2,4-diisocyanate, 4,4′4″-triphenylmethane triisocyanate, polymethylene polyohenylisocyanate, tolylene-2,4,6-triisocyanate, 4,4′-dimethyldiphenylmethane-2,2′5,5′-tetraisocyanate, and mixtures thereof.

Preferably, however, the isocyanate component of the polyurethane foam is selected from the group consisting of methyl diphenyl diisocyanate (MDI), toluene diisocyanate (TDI), hexamethylene diisocyanate (HMDI), hexamethylene diisocyante (HDI), isophorone diisocyanate (IPDI), TMXDI (1,3-bis-isocyanato-1-methylene ethylene benzene), or any of their oligomers, pre-polymers, dimmers, trimers, allophanates and uretidiones.

The polyol portion of the polyurethane foam can be any suitable polyol commonly used within the art, and can include aliphatic or aromatic polyols, including polyester, polyether, and caprolactone-based polyols. The polyols include materials such as glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5,1,2,6-hexanetriol, 1,1,1,-trimethylolpropane, or the like, or can be made by any suitable production method which would typically and preferably involve reacting ethylene oxide (EO), propylene oxide (PO) or butylene oxide (BO) with materials such as: 1,1,1-tris[(2-hydroxyethoxy)methyl]ethane, 1,1,1,-tris-[(2-hydroxypropoxy)methyl]propane, triethanolamine, triisopropanolamine, pyrogallol or phloroglucinol, in order to form a chain-extended polyol.

One example of a suitable chain-extended polyol is the polyether triol sold under the trade name XD 1421, which is made by the Dow Chemical Company. It has a molecular weight of around 4900, and is composed of a ratio of three oxyethylene (ethylene oxide) units randomly copolymerized per one unit of oxypropylene (propylene oxide). It has a hydroxy content of 0.61 meq. OH/g.

Another example of a material which is commercially available is Pluracol V-7 made by BASF Wyandotte which is a high molecular weight liquid polyoxyalkylene polyol. Other polyols which might be used at polyether polyols such as Pluracol 492 from BASF, having a molecular weight of 2000. Alternatively, saturated polyester polyols such as Desmophen 2500 from Bayer, having a molecular weight of 1000 might be used. Further, castor oils such as DB caster oil or regular commercial grades of castor oil available from for example, CAS Chem, might also be used.

Additionally, polybutadiene resins, such as Poly BD R45T, available from Sartomer, can also be used.

Still further, the polyol can be selected from renewable sources, such as soy, castor and vegetable oil, or the like, or combinations thereof.

As such, a wide variety of polyols might be used. Moreover, combinations of various polyols, or even different types of polyols, might also be used.

The ratio of isocyanate resin to polyol is typically identical to the ratios normally used in the prior art to cure these types of polymer systems. Preferably, however, the amount of resin in this mixture is in the amount of from 1 to 40%, and more preferably in the ratio of from 2 to 30%. The skilled artisan will be aware that these ranges will vary, however, depending on the resins selected, and on the desired properties of the polymer system.

Further, as is known in the art, the foam structure of the polyurethane material is provided by a blowing agent which acts to form the voids within the polyurethane as it reacts and solidifies. The nature, types and amounts of blowing agents which are used in) polyurethane foam manufacture are well known to those skilled in the art, but can include, for example, water, carbon dioxide, hydrofluorocarbons, chlorinated fluorocarbons and the like. Again, though the skilled artisan will easily be able to determine suitable blowing agents.

Additionally, other additives such as catalysts or surfactants can be added to the reaction mixture in order to control various properties.

Catalysts, when used, can be amine based, including, for example, primary, secondary or tertiary amines or combinations thereof. The catalysts can also be metallic based, including, for example, tin, lead, bismuth based catalysts, or the like. Catalysts can be used which promote the formation of urethane linkages in the polyurethane based systems, by reaction of isocyanate groups and hydroxyl groups. These types of amine catalysts include, for example, triethylenediamine, N-methylmorpholine, tetramethyl-2,4-butanediamine, N-methylpiperazine, dimethylthanolamine, triethylamine, and the like; and organometallic compounds, such as stannous octanoate, dibutyltin dilaurate, dibutyltin di-2-ethylhexanoate, and the like.

The catalysts may be used alone or in combination with one another. The amount of catalyst typically used is a broad range of amounts, which usually ranges from 0.03 to 2.0 parts by weight, and preferably between 0.02 to 1.2 parts by weight based on the total weight of the composition, exclusive of the reinforcing materials.

Surfactants might also be added. By introducing surfactants, the foam materials can be made as closed cell or open cell depending upon the desired application. Where uniformity of cell structure is required, fine organic or inorganic particles may be used in a size range between 50 and 500 microns. Where random cell structure is acceptable, larger reinforcing particles may be used. Surfactants, when used, are preferably silicone based, although any suitable surfactant might be used.

Other materials can be included in the formulations of the present invention. For example, coupling agents, such as silane or titanates, may also be included in the preparation of the composition to improve the physical properties of the material. Where) other properties are desired additives may be added to the composition including colorants, dry or liquid inks or pigments, fire and flame retardants, internal mold release additives, antistatic agents, and such other additives as required, and which are known within the industry.

As indicated above, once the foam is fully formed and cured, the final density is preferably less than 10 lbs per cubic foot. More preferably, the density is between 0.01 and 5 lbs per cubic foot, and an even more preferred density will be in the range of between 0.35 to 3 lbs per cubic foot.

The production method used to produce the polyurethane material for the polyurethane batts of the present invention will be similar to the techniques used in the prior art for other products. This production method, or foam forming stage, is preferably conducted under heat and/or pressure, and is preferably accomplished using: an injection molding process; an extrusion process; a calendaring process; a compression molding process; a spray foam application process; a slab stock foam process; a rotational molding process; or any other suitable foam forming process. As such, any suitable conventional or non-conventional manufacturing processes might be used for the forming stage.

The polyurethane foam can be produced so that it foams to the desired size and shape by injecting the reactant materials into a suitable mold, or the like. Alternatively, larger blocks of material can be produced, which can be cut into the proper size and shape necessary to provide a flexible polyurethane batt. Cutting of the polyurethane foam can be accomplished in a number of different ways which are known to those skilled in the art. This might include knives, guillotines, or hot wire technologies in order to cut the foam to the desired shape and size.

Once the foam has been formed or cut to size, it is preferably compressible such that it can be compressed for placement into a shipping container, in a manner similar to fibreglass baits. This is particularly true for the flexible polyurethane materials. The container might simply be a plastic bag or wrap which can be used to ship the compressed foam to the job site. Once on site, the container can be opened so that the compressed foam will essentially automatically expand back to its normal shape.

As such, the preferably flexible, compressible polyurethane foam expands back to its original shape and size once the compressive force is removed. Thus, preferred flexible polyurethane foam materials are preferred and this includes those materials which, as hereinabove described, can be compressed in size, by an applied force, in at least one dimension, to a value which is less than about 60%, and more preferably less than about 50%, and still more preferably less than about 30%, of its original size. As such, for example, a 4 foot high collection of polyurethane bats might be compressed to 2 feet in height, while still being approximately 4 feet long, and 16 inches wide. This collection of polyurethane batts would be suitable for insertion into a plastic bag having dimensions of 4 feet, by 2 feet by 15 inches.

Production of the polyurethane batts of the present invention utilizes traditional polyurethane foam production techniques. Typically the polyol and isocyanate resins are mixed together with mixing. Mixing of the materials preferably involves the use of an efficient shear mixer to homogeneously blend either or both of the resin components together, and/or mix or pre-mix either component directly with any necessary additives. Then, after mixing the isocyanate and polyol components together, the resultant composition is introduced into a mold cavity, or extruded through a die, calendered, sprayed on a surface, or applied in some other processing method, and is caused to react to form the polyurethane foam.

The composition may be pumped, blown, sprayed, or poured into a forming tool or mold cavity, depending on the physical nature of the pre-polymer mixture. To improve the processing speed the forming tool, or mold, may be heated thereby promoting a faster reaction.

Those skilled in the art will be aware that tooling should be provided which preferably will allow excess gasses to exit the formulation so as to allow the composition to expand to the tool surface and thus providing for a uniform surface that is preferably smooth and free of pitting.

Prior to introducing the composition material into the forming tool, a release agent or coating in the form of a gel-coat system can be applied to the surface of the tool. The release agent or in-mold coating may comprise acrylic, urethane, melamine vinyl, silicone, epoxy, polyester coatings and combinations thereof to achieve the desired appearance and surface features.

Surface features such as a variety of textures may be applied to the tool surface to be molded into the final product.

The foaming process can occur when, for example, the isocyanate from the blended pre-polymer resin reacts with moisture (water) which causes carbon dioxide gas) to be liberated. A chemical blowing agent such as nitrogen, pentane, carbon dioxide, etc., may also be used directly or released in a reaction to form a foam. The foam can also be co-blown by combinations of materials such as a combination of water and a hydrocarbon material such as pentane, and with HCFC's or HFC's like HFC-245fa (as those terms are used in the industry). The foam may also be co-blown with gases like carbon dioxide or nitrogen, that are injected into the raw material, or into the mixing streams of the reactants.

Alternatively, water can be added to the reaction system, or some other blowing agent can be added to generate a gaseous material during the curing reaction. Preferably, the flexible material is such that it provides a foam material that once formed, is essentially fully cured and crosslinked. As such, the polyurethane foam will not “off gas” to any appreciable extent. Those skilled in the art would be aware of techniques to achieve this state.

The material of the present invention can be foamed under atmospheric conditions, but might also be produced in a system which is under a compressive pressure. Under these conditions, compression pressures of 0 to 1,000 psi (0 to 70.30 kg/cm²) can be applied. The polyurethane foam material of use in the present invention can also be custom formulated and engineered for specific applications. The range of formulations includes using rigid, semi-rigid, or more preferably semi-flexible or flexible, polyurethane foams that may include a range of organic and inorganic reinforcing materials which may be in the form of a particle or fiber with the said reinforcing materials being in a variety of densities, sizes and regular and irregular shapes.

The polyurethane foam can be produced having either a closed cell or open cell structure, in accordance with prior art techniques and practices. The cell size in the foam can be any suitable size, and this can be easily adjusted and modified by the skilled artisan. It can be noted that the density of the batt can be modified to some extent by adjustment of the cell size. Preferred cell sizes are between 0.001 cm to 1 cm, and more preferably, between 0.001 cm and 0.5 cm.

The batt can be made to different sizes and shapes, but preferably, the polyurethane batts of the present invention are similar in size and shape to the common fibreglass batts, or insulation sheets, already used in the industry. In particular, the flexible or semi-flexible batts can be preferably produced having a width of about 12 inches, 16 inches, 24 inches or even 48 inches, and a thickness of between 1 and 10 inches, and more preferably between 2 and 6 inches. The insulating ability, or “R-value”, provided by the batt will largely be dependent on the thickness of the batt for a given formulation or composition. The length of the batt can vary, but typically will be between 2 and 10 feet, and more preferably, between 3 and 6 feet. However, the batt might also be provided in longer rolls of up to, for example 50 feet or more, so that it can be cut to length on site.

Most commonly, however, the batt will be about 16 inches wide, about 48 inches long, and about 4 to about 6 inches thick. When compressed, for shipping or the like, the compressed batt will typically have dimensions of 16 inches wide, 48 inches in length, and a thickness of less than 2 inches. More preferably, the compressed batt will have a thickness of between about 1 to about 2 inches.

The polyurethane batt can also be provided in larger formats, such as, for example, a batt which is 8 feet long, and 50 feet wide. The thickness can vary depending on the desired R-value. This batt would be suitable for coverage of, for example, the inner surface of an unfinished basement wall, or the like, or for applying to a flat surface.

The rigid or semi-rigid polyurethane batts can be produced in similar sizes, but most commonly, would be expected to be in a 4 foot by 8 foot sheet, having a thickness of between 1 inch and 6 inches, and more preferably, having a thickness between 1.9 inches and 3.1 inches.

The batt can be produced so as to have a exposed cell structure on any or all of the 6 surfaces, or a standard cube shaped batt. The batt might also include 1 to 6 surfaces which have a enclosed cell structure wherein there is a continuous “skin” on the surface) of the batt. For example, the inner and outer larger surfaces of a batt might have a continuous skin, while the side and end surfaces might have exposed cells as a result of the cutting or trimming of a larger batt. However, numerous variations from this arrangement are possible depending on the production technique, and desired application.

The batt could also be provided so as to be exposed cells on all sides, or have a enclosing skin on all sides.

The enclosed cell structure, having a skin, can also act as a vapour barrier. However, a vapour barrier component can also be added to the batt by attaching (by gluing or the like), a continuous layer of plastic such as polyethylene film, on at least one surface of the batt. The film would typically have a thickness of between 1 and 20 mil, and more preferably between 3 and 10 mil.

The final batt product may also be laminated with foils or plastic to suit different needs of the user, or to comply with building codes or other regulations.

A benefit of the use of the polyurethane foam as insulation, is that it is typically unaffected by water which may be present, on occasion. If exposed to water, the polyurethane batt will simply dry when the water is removed, and again provide the same insulation value.)

The polyurethane batt of the present invention can be used in any application where traditional fibreglass batts are used. This could include, for example, residential, commercial, or industrial applications where insulation for heating or cooling is required. The polyurethane batt could also be used for sound absorption, as well as other suitable applications where batt materials might be used. Still further, the batt foam material can also be shredded in order that it can be used in a blown insulation application. For this application, the foam batt can be shredded to a size suitable for blown insulation applications, as known to those skilled in the art, but typically in the range of from 0.5 to 10 cm pieces. A variety of other applications will be apparent to those skilled in the art.

### EXAMPLES

The following non-limiting example provides an indication of suitable compositions for a polyurethane foam according to the present invention. Of course, the skilled artisan will be well aware that modifications of the present formulation can be easily accomplished by simple experimentation.

Suitable open and closed cell polyurethane batts were prepared according to the following formulations.

### Example 1

### Rigid Closed Cell System

| | | | |
|---|---|---|---|
| Mondur MR | 50% | Poperties: | Density, 2.0 lbs/cubic foot |
| Jeffol R470X | 32% | | Compressive Strength, 22 psi |
| Antiblaze 80 | 6.4% | | Closed cell, 92% |
| DC-193 | 0.5% | | K factor, 0.112 |
| Water | 0.4% | | |
| Polycat 8 | 0.2% | | |
| HCFC 141b | 10.5% | | |

The above constituent elements were mixed together at room temperature in a suitable mould, and were allowed to foam to form a rigid closed cell batt. Approximately, 10.66 lbs. of material were used to prepare a batt having dimensions of 4 feet by 10 feet by 2 inches (or 5.333 cubic feet). This would be a suitable replacement for a typical insulation sheet made of Styrofoam™, or the like, as provided in the prior art.

### Example 2

### Flexible Open Cell System

| | | | |
|---|---|---|---|
| TDI-80 | 32% | Properties: | Density, 1.1 lbs/cubic foot |
| Jeffol G31-55 | 60% | | Tensile, 16 psi |
| Fyrol PCF | 4% | | Tear, 2.2 pli |
| Water | 3% | | Elongation, 195% |
| DC-5125 | 0.5% | | Ball rebound, 36% |
| Dabco 33LV | 0.1% | | Airflow, 4.1 cfm |
| Niax A-1 | 0.1% | | K factor, 0.21 |
| Stannous octoate | 0.3% | | |

Again, the above constituent elements were mixed together at room temperature in a suitable mould, and were allowed to foam to form a flexible open cell batt. Approximately, 1.96 lbs. of material was used to prepare a batt having dimensions of 4 feet by 4 inches by 16 inches (or 1.7777 cubic feet). This material is particularly suited for replacement for a typical fibreglass batt of the prior art, while having similar density and flexibility.

Thus, it is apparent that there has been provided, in accordance with the present invention, a foam material, and a method of production of the foam material, which fully satisfies the goals, objectives, and advantages set forth hereinbefore.

Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Also, while this discussion has addressed prior art known to the inventor, it is not an admission that all art discussed is citable against the present application.

We claim:

1. Use of a rigid, semi-rigid, or more preferably, a semi-flexible or flexible polyurethane foam material as a insulation material, wherein said polyurethane material is provided as a foam material in the shape of an insulation batt.

2. Use as claimed in claim 1 wherein said polyurethane foam material is a semi-flexible or flexible material.

3. Use as claimed in claim 1 wherein said polyurethane foam material has a size and shape similar to that of prior art insulation batts.

4. Use as claimed in claim 1 wherein said polyurethane material is adapted to be attached to a building structure, including a wall, roof, or foundation structure in a residential, commercial or industrial building, in order to provide insulation properties, and wherein said polyurethane material optionally contains or provides a vapour barrier.

5. Use as claimed in claim 1 wherein said polyurethane material is provided by reaction of an isocyanate-containing material with a polyol.

6. Use as claimed in claim 5 wherein said isocyanate-containing material is selected from the group consisting of methyl diphenyl diisocyanate (MDI), toluene diisocyanate (TDI), hexamethylene diisocyanate (HMDI), hexamethylene diisocyante (HDI), isophorone diisocyanate (IPDI), TMXDI (1,3-bis-isocyanato-1-methylene ethylene benzene), or any of their oligomers, pre-polymers, dimmers, trimers, allophanates and uretidiones.

7. Use as claimed in claim 5 wherein said polyol is which is selected from the group consisting of glycerol, 3-(2-hydroxyethoxy)-1,2-propanediol, 3-(2-hydroxypropoxy)-1,2-propanediol, 2,4-dimethyl-2-(2-hydroxyethoxy)-methylpentanediol-1, 5 or 1,2,6-hexanetriol, 1,1,1,-trimethylolpropane or is made by reacting ethylene oxide (EO), propylene oxide (PO) or butylene oxide (BO) with: 1,1,1-tris[(2-hydroxyethoxy)methyl]ethane, 1,1,1,-tris-[(2-hydroxypropoxy)methyl]propane, triethanolamine, triisopropanolamine, pyrogallol or phloroglucinol, in order to form a chain-extended polyol.

8. Use as claimed in claim 5 wherein said polyol is selected from renewable sources.

9. Use as claimed in claim 8 wherein said polyol is soy, castor or vegetable oil, or combinations thereof.

10. Use as claimed in claim 1 wherein said foamed polyurethane has an entrained cell structure so as to provide a variety of entrained voids within the polyurethane material, and wherein said foamed polyurethane has an open or closed cell structure.

11. Use as claimed in claim 1 wherein said polyurethane foam has a density of less than 10 pounds per cubic foot.

12. Use as claimed in claim 11 wherein said density is between 0.1 and 5 lbs per cubic foot.

13. Use as claimed in claim 1 wherein a 4 inch thickness batt of polyurethane material has an “R” value of between 10 and 30.

14. Use as claimed in claim 1 wherein said polyurethane foam is a flexible or semi-flexible foam which is compressible such that it can be compressed for placement into a shipping container, in a manner similar to fibreglass batts.

15. Use as claimed in claim 1 wherein said polyurethane foam can be compressed in size, by an applied force, in at least one dimension, to a value which is less than about 60%, of its original size, and then return to its original size when said force is released.

16. A polyurethane batt, for use in insulating a building structure, wherein said polyurethane batt is produced from a rigid, semi-rigid, semi-flexible or flexible polyurethane foam material.

17. A polyurethane batt as claimed in claim 16 wherein said polyurethane batt is produced from a semi-flexible or flexible polyurethane foam.

18. A method for the production of a polyurethane batt for use as an insulation batt, wherein a polyol and an isocyanate resins are mixed together, optionally with any additional additives, and the resultant composition is introduced into a mold cavity, or extruded through a die, calendered, sprayed on a surface, or applied in some other processing method, in order to cause the polyol and isocyanate resins to react, and either blown, co-blown, or reacted to cause a gassing reaction to occur, in order to form a polyurethane foam in the form of a insulation batt.

19. A method as claimed in claim 18 wherein polyurethane foam reaction is conducted under heat and/or pressure, and is accomplished using: an injection molding process; an extrusion process; a calendaring process; a compression molding process; a spray foam application process; a slab stock foam process; or using a rotational molding process.

20. A method as claimed in claim 18 wherein said polyurethane foam is a rigid, semi-rigid, semi-flexible or flexible polyurethane foam.

21. A method as claimed in claim 20 wherein said polyurethane foam is a flexible polyurethane foam.

22. A method of producing a polyurethane foam batt insulation comprising preparing a polyurethane foam material as claimed in claim 21, compressing said polyurethane foam in at least one dimension to form a compressed polyurethane foam, and inserting said compressed polyurethane foam into a shipping container.

23. A method as claimed in claim 22 wherein said shipping container is a plastic bag.

24. A method of producing an insulation material comprising preparing a polyurethane foam material as claimed in claim 18, shredding said foam material to a size suitable for use in blown insulation applications.
